(19) United States
(12) Patent Application Publication
(10) Pub. No.: US 2025/0372826 A1
(43) Pub. Date: Dec. 4, 2025

(54) BUSBAR MODULE DESIGNS FOR SCALABLE TRACTION BATTERY SYSTEMS

(71) Applicant: FORD GLOBAL TECHNOLOGIES, LLC, Dearborn, MI (US)

(72) Inventors: Yongcai Wang, Ann Arbor, MI (US); Brian Utley, Canton, MI (US); Jerry Lan, Ann Arbor, MI (US); Kwon Shon, Troy, MI (US); Chi Paik, Grosse Ile, MI (US); Frank Kim, South Lyon, MI (US)

(21) Appl. No.: 18/676,857

(22) Filed: May 29, 2024

(51) Int. Cl. H01M 50/507; B60L 50/64; H01M 50/213; H01M 50/249; H01M 50/262; H01M 50/503; H01M 50/516

(52) U.S. Cl. CPC H01M 50/507; B60L 50/64; H01M 50/213; H01M 50/249; H01M 50/262; H01M 50/503; H01M 50/516; H01M 2220/20

(57) ABSTRACT

Busbar modules are provided for electrically connecting battery cells of a battery system for a traction battery pack. The busbar modules may include a scalable design for accommodating battery systems of all sizes and design requirements. An exemplary busbar module may include a busbar frame and a busbar system positionable relative to a grouping of battery cells by the busbar frame. The busbar system may include a negative terminal, a positive terminal, a plurality of short busbars, and a long busbar.

### TECHNICAL FIELD

This disclosure relates generally to traction battery packs, and more particularly to busbar modules for electrically connecting battery cells of a traction battery pack.

### BACKGROUND

Electrified vehicles include a traction battery pack for powering electric machines and other electrical loads of the vehicle. Traction battery packs include a plurality of battery cells. The battery cells must be reliably connected to one another in order to provide the necessary voltage and power levels necessary for achieving vehicle propulsion.

### SUMMARY

A battery system according to an exemplary aspect of the present disclosure includes, among other things, a grouping of battery cells, and a busbar module arranged to electrically connect the grouping of battery cells. The busbar module includes a busbar frame and a busbar system. The busbar system includes a negative terminal, a positive terminal, a plurality of short busbars, and a long busbar.

In a further non-limiting embodiment of the foregoing battery system, the grouping of battery cells includes cylindrical battery cells.

In a further non-limiting embodiment of either of the foregoing battery systems, the busbar frame includes a round window that establishes a welding access point for welding a positive portion of the busbar system to the grouping of battery cells.

In a further non-limiting embodiment of any of the foregoing battery systems, each of the plurality of short busbars includes an arched body and a pair of legs that project outwardly from the arched body.

In a further non-limiting embodiment of any of the foregoing battery systems, the arched body includes a lobe having a shape that mimics that of the round window.

In a further non-limiting embodiment of any of the foregoing battery systems, the busbar frame includes a crescent-shaped window that establishes a welding access point for welding a negative portion of the busbar system to the grouping of battery cells.

In a further non-limiting embodiment of any of the foregoing battery systems, each of the plurality of short busbars includes an arched body and a pair of legs that project outwardly from the arched body.

In a further non-limiting embodiment of any of the foregoing battery systems, each of the pair of legs includes a curved end portion having a shape that mimics that of the crescent-shaped window.

In a further non-limiting embodiment of any of the foregoing battery systems, the busbar frame includes a hexagonal-shaped window configured for directing a cooling airflow toward the grouping of battery cells.

In a further non-limiting embodiment of any of the foregoing battery systems, the grouping of battery cells is held within a bottom enclosure frame.

In a further non-limiting embodiment of any of the foregoing battery systems, the busbar frame is mounted to the bottom enclosure frame by at least one fastener.

In a further non-limiting embodiment of any of the foregoing battery systems, the plurality of short busbars are identically sized and shaped with one another.

A traction battery pack according to another exemplary aspect of the present disclosure includes, among other things, an enclosure assembly, and a battery system housed within the enclosure assembly. The battery system includes a bottom enclosure frame, a grouping of cylindrical battery cells held within the bottom enclosure frame, a busbar module arranged over the grouping of cylindrical battery cells and including a busbar frame and a busbar system, and a first fastener that secures the busbar frame to the bottom enclosure frame.

In a further non-limiting embodiment of the foregoing traction battery pack, the bottom enclosure frame establishes a bottom section of an enclosure frame of the battery system, and the busbar frame establishes a top section of the enclosure frame.

In a further non-limiting embodiment of either of the foregoing traction battery packs, the first fastener is received through a fastener housing of the busbar frame and extends into a stanchion of the bottom enclosure frame.

In a further non-limiting embodiment of any of the foregoing traction battery packs, the busbar frame includes a plurality of round windows and a plurality of crescent-shaped windows.

In a further non-limiting embodiment of any of the foregoing traction battery packs, the plurality of round windows establish first welding access points for welding a positive portion of the busbar system to the grouping of cylindrical battery cells, and the plurality of crescent-shaped windows establish second welding access points for welding a negative portion of the busbar system to the grouping of cylindrical battery cells.

In a further non-limiting embodiment of any of the foregoing traction battery packs, the busbar system electrically connects the grouping of cylindrical battery cells in a parallel/series configuration.

In a further non-limiting embodiment of any of the foregoing traction battery packs, a spacer spaces the bottom enclosure frame apart from an enclosure tray of the enclosure assembly.

In a further non-limiting embodiment of any of the foregoing traction battery packs, the busbar system includes a negative terminal, a positive terminal, a plurality of short busbars, and a long busbar.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates an exemplary battery system of a traction battery pack.

FIG. 3 is an exploded view of the battery system of FIG. 2.

FIG. 4 illustrates select portions of the battery system of FIG. 2.

FIG. 5 illustrates a busbar system of the battery system of FIG. 2.

FIG. 6 illustrates the attachment of a busbar of the busbar system of FIG. 5 to a battery cell.

### DETAILED DESCRIPTION

This disclosure details busbar modules for electrically connecting battery cells of a battery system for a traction battery pack. The busbar modules may include a scalable design for accommodating battery systems of all sizes and design requirements. An exemplary busbar module may include a busbar frame and a busbar system positionable relative to a grouping of battery cells by the busbar frame. The busbar system may include a negative terminal, a positive terminal, a plurality of short busbars, and a long busbar. These and other features are discussed in greater detail in the following paragraphs of this detailed description.

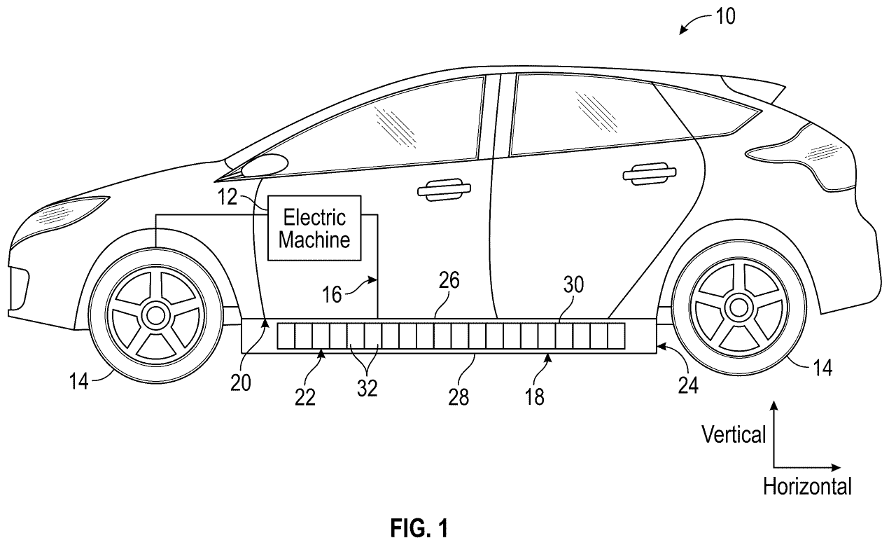

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include a battery system 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the battery system 22.

The battery system 22 may include one or more groupings of battery cells 32. Once electrically coupled, the battery cells 32 may supply electrical power for powering various components of the electrified vehicle 10. The total number of battery cells 32 included as part of the battery system 22 is not intended to limit this disclosure.

The size of the battery system 22 is scalable to address various manufacturing and packaging requirements of the traction battery pack 18. In an embodiment, the battery cells 32 are arranged in a single, large format battery cell grouping, which may be referred to as a cell matrix when the battery system 22 is configured as a structurally integrated type battery system. However, other configurations are also possible. For example, in another embodiment, the battery cells 32 could alternatively be grouped together into two or more individual battery arrays/modules that are electrically connected with one another for establishing the battery system 22.

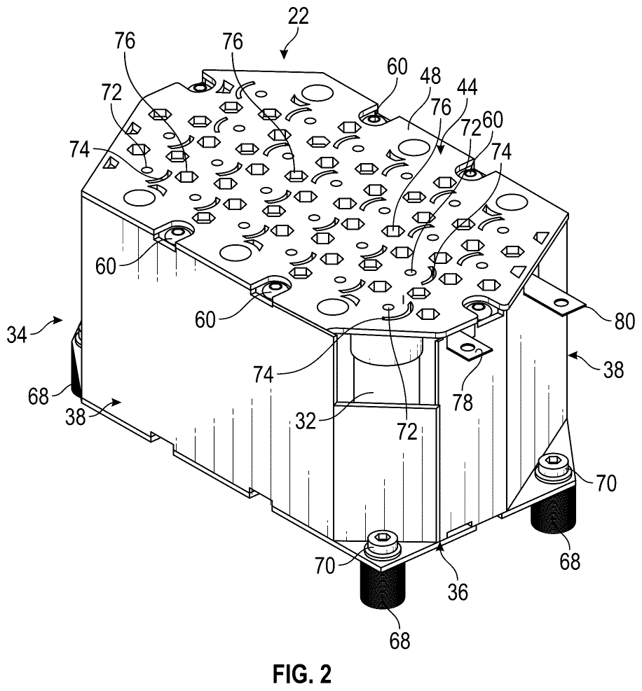

Referring now to FIGS. 2, 3, and 4, the battery cells 32 of the battery system 22 may be cylindrical lithium-ion cells. However, battery cells having other geometries and/or other chemistries could alternatively be utilized within the scope of this disclosure. The size of each battery cell 32 could vary depending on the overall design requirements of the traction battery pack 18 and is therefore not intended to limit this disclosure.

The battery cells 32 of the battery system 22 may be packaged together and held within an enclosure frame 34. The enclosure frame 34 may be a separate structure from the enclosure assembly 24 of the traction battery pack 18. The enclosure frame 34 may be made of any suitable plastic material, for example.

The enclosure frame 34 may include a bottom enclosure frame 36. The bottom enclosure frame 36 may include a plurality of pockets 35, with each pocket 35 being sized to receive a bottom portion of one of the battery cells 32 of the battery system 22. Each pocket 35 may be established by a set of tabs 40 that protrude upwardly from a floor 42 of the bottom enclosure frame 36.

In some implementations, the enclosure frame 34 may additionally include a pair of side enclosure frames 38. The bottom enclosure frame 36 and the side enclosure frames 38 can be arranged together in a manner that at least partially surrounds the grouping of battery cells 32.

The battery system 22 may additionally include a busbar module 44 configured to electrically connect the battery cells 32 of the battery system 22. The busbar module 44 may be arranged to extend in span across top surfaces 46 of the battery cells 32. However, other configurations are also contemplated within the scope of this disclosure.

The busbar module 44 may include a busbar frame 48 and a busbar system 50. The busbar frame 48 may be configured for positioning and retaining the busbar system 50 relative to the battery cells 32. The busbar frame 48 may position the busbar system 50 directly over top of the battery cells 32 for locating the busbar system 50 at the proper position for securing (e.g., welding) the busbar system 50 to terminals 52 of the battery cells 32.

In some implementations, the busbar frame 48 establishes a top section of the enclosure frame 34. The busbar frame 48, the bottom enclosure frame 36, and the side enclosure frames 38 can be arranged together in a manner that at least partially surrounds the grouping of battery cells 32 of the battery system 22.

The busbar frame 48 may be secured directly to the bottom enclosure frame 36 by a plurality of fasteners 54 (e.g. screws). Each fastener 54 may be inserted through a fastener housing 56 of the busbar frame 48 before engaging a stanchion 58 of the bottom enclosure frame 36 in order to mount the busbar frame 48 to the bottom enclosure frame 36. In an embodiment, the fastener housings 56 protrude vertically downward from the busbar frame 48 in a direction toward the bottom enclosure frame 36, and the stanchions 58 protrude vertically upward from the floor 42 of the bottom enclosure frame 36 in a direction toward the busbar frame 48. The stanchions 58 may extend a greater distance from the floor 42 than the tabs 40 and are thus positioned closer to the busbar frame 48 than the tabs 40 when the battery system 22 is fully assembled.

The side enclosure frames 38 may be secured to the busbar frame 48 and the bottom enclosure frame 36 by an additional plurality of fasteners 60 (e.g., screws). A first portion of the fasteners 60 may be inserted through mounting holes 64 formed in the busbar frame 48 before engaging fastener housings 62 of the side enclosure frame 38, and a second portion of the fasteners 60 may be inserted through mounting holes 66 of the bottom enclosure frame 36 before engaging the fastener housings 62.

Spacers 68 may be mounted to the bottom enclosure frame 36 on an opposite side from the tabs 40 and the stanchions 58 by additional fasteners 70. The spacers 68 may space the bottom enclosure frame 36 apart from the enclosure tray 28 of the enclosure assembly 24 in an assembled condition of the traction battery pack 18.

A plurality of windows may be formed through the busbar frame 48. For example, the busbar frame 48 may include round windows 72, crescent-shaped windows 74, and hexagonal shaped windows 76 (best shown in FIG. 2). Although round, crescent-shaped, and hexagonal-shaped windows are specifically shown and described herein, other shapes could be utilized within the scope of this disclosure.

The round windows 72 and the crescent-shaped windows 74 may establish different welding access points for welding the busbar system 50 to the battery cells 32. In an embodiment, each round window 72 is located at a position that is directly over top of a positive portion of the busbar system 50 for facilitating welding, and each crescent-shaped window 74 is located at a position that is directly over top of a negative portion of the busbar system 50 for facilitating welding. The windows 72, 74 are large enough to receive tooling for facilitating welding operations, such as laser welding operations, for example, but small enough to prevent finger access to the busbar system 50. The windows 72, 74 therefore provide “finger-proof” features for preventing inadvertent exposure to high voltage areas of the battery system 22.

The hexagonal-shaped windows 76 may be configured to allow cooling airflow to pass through the busbar frame 48 for cooling the battery cells 32. The hexagonal-shaped windows 76 may additionally establish vent gas exit paths for expelling battery vent byproducts, such as gases or other byproducts, from the battery cells 32 during certain battery venting events.

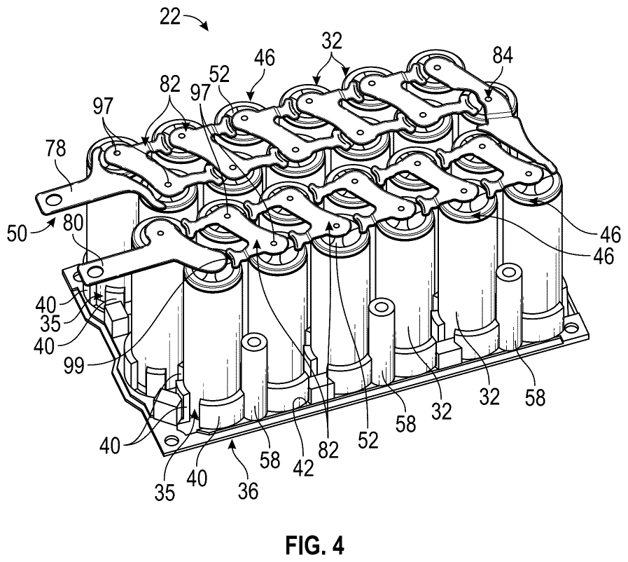

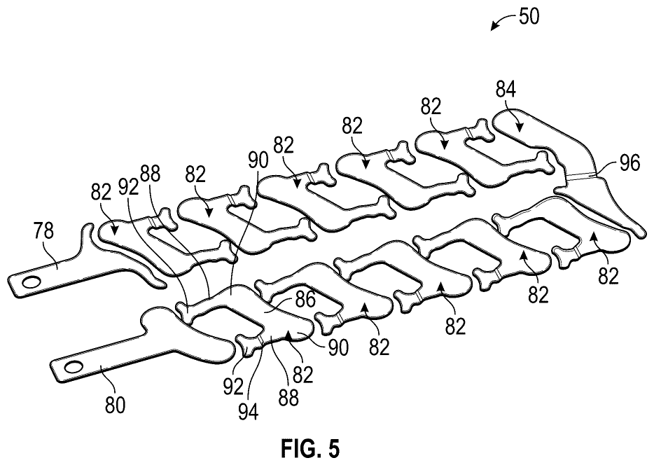

Referring now primarily to FIGS. 4 and 5, the busbar system 50 may be configured to electrically connect the battery cells 32 of the battery system 22 in a parallel/series configuration. In an embodiment, the battery cells 32 are connected in a 2P12S configuration (2 cells in parallel by 12 cells in series). However, other cell configurations are contemplated within the scope of this disclosure.

The busbar system 50 may include a negative terminal 78, a positive terminal 80, a plurality of short busbars 82, and one or more long busbars 84. In an embodiment, the negative terminal 78, the positive terminal 80, the plurality of short busbars 82, and the long busbar 84 are arranged together to establish a generally U-shaped design of the busbar system 50. However, other configurations are contemplated within the scope of this disclosure.

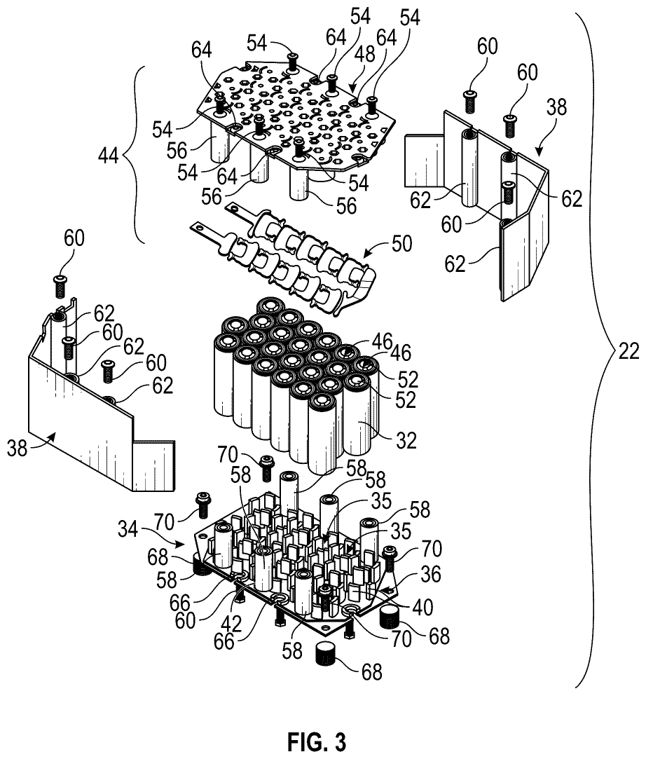

The total number of short busbars 82 and long busbars 84 provided within the busbar system 50 may vary and could depend on the number of battery cells 32 provided within the battery system 22, among various other design factors. The busbar system 50 should therefore not be considered limited to the specific configuration shown in FIGS. 2 and 3.

The short busbars 82 and the long busbar 84 may be stamped, relatively thin strips of metal that are configured to conduct the power stored within the battery cells 32 of the battery system 22. Example busbar materials include copper, brass, or aluminum, although other conductive materials may also be suitable.

Each short busbar 82 may electrically connect the terminals 52 of adjacent battery cells 32 together in parallel. The short busbars 82 may each be identically sized and shaped and may each include an arched body 86 and a pair of legs 88 that project outwardly at opposite ends of the arched body 86.

The arched body 86 may include a pair of lobes 90. Each lobe 90 may include a shape that mimics that of the round windows 72 of the busbar frame 48 to facilitate welding at the positive portions of the busbar system 50. In an exemplary embodiment, the lobes 90 may thus embody a substantially round-shaped design that matches the shape of the round windows 72. The lobes 90 may be secured to the positive terminals 52 of the battery cells 32 by laser welds 97 (see, e.g., FIG. 4).

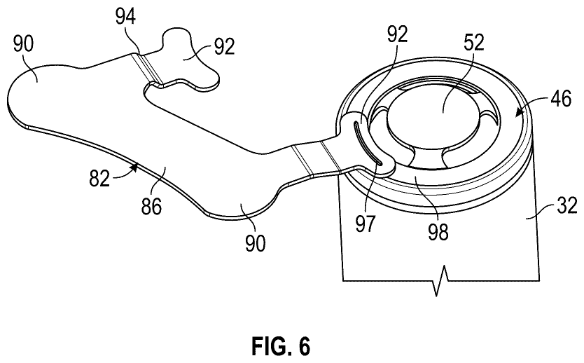

Each leg 88 may include a curved end portion 92. Each curved end portion 92 may include a shape that mimics that of the crescent-shaped windows 74 to facilitate welding at the negative portions of the busbar system 50. In an exemplary embodiment, the curved end portions 92 of the legs 88 may thus embody a crescent-shaped design that matches the shape of the crescent-shaped windows 74. The curved end portions 92 may be secured to a negative can shoulder 98 of the battery cells 32 by a laser weld 99 (see, e.g., FIG. 6).

At least one leg 88 of each short busbar 82 may additionally include a bend 94. The bends 94 may be configured for accommodating dimensional variances between adjacent battery cells 32 of the battery system 22.

The long busbar 84 may electrically connect together in series adjacent strings of battery cells 32 that are electrically connected by the short busbars 82. The long busbar 84, which is larger than the short busbars 82 in the lengthwise direction, may include a bend 96 for accommodating dimensional variances between the adjacent battery cell 32 strings. The negative terminal 78 may be electrically connected to one of the adjacent battery cell 32 strings, and the positive terminal 80 may be electrically connected to the other of the adjacent battery cell 32 strings.

The exemplary busbar modules of this disclosure provide simple and reproduceable designs for electrically connecting battery cells within a traction battery pack system. The designs are scalable and thus can be used with battery systems of all sizes and design requirements.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery system, comprising:
a grouping of battery cells;
a busbar module arranged to electrically connect the grouping of battery cells, wherein the busbar module includes a busbar frame and a busbar system; and
the busbar system including a negative terminal, a positive terminal, a plurality of short busbars, and a long busbar.

2. The battery system as recited in claim 1, wherein the grouping of battery cells includes cylindrical battery cells.

3. The battery system as recited in claim 1, wherein the busbar frame includes a round window that establishes a welding access point for welding a positive portion of the busbar system to the grouping of battery cells.

4. The battery system as recited in claim 3, wherein each of the plurality of short busbars includes an arched body and a pair of legs that project outwardly from the arched body.

5. The battery system as recited in claim 4, wherein the arched body includes a lobe having a shape that mimics that of the round window.

6. The battery system as recited in claim 1, wherein the busbar frame includes a crescent-shaped window that establishes a welding access point for welding a negative portion of the busbar system to the grouping of battery cells.

7. The battery system as recited in claim 6, wherein each of the plurality of short busbars includes an arched body and a pair of legs that project outwardly from the arched body.

8. The battery system as recited in claim 7, wherein each of the pair of legs includes a curved end portion having a shape that mimics that of the crescent-shaped window.

9. The battery system as recited in claim 1, wherein the busbar frame includes a hexagonal-shaped window configured for directing a cooling airflow toward the grouping of battery cells.

10. The battery system as recited in claim 1, wherein the grouping of battery cells is held within a bottom enclosure frame.

11. The battery system as recited in claim 10, wherein the busbar frame is mounted to the bottom enclosure frame by at least one fastener.

12. The battery system as recited in claim 1, wherein the plurality of short busbars are identically sized and shaped with one another.

13. A traction battery pack, comprising:
an enclosure assembly; and
a battery system housed within the enclosure assembly, wherein the battery system includes:
a bottom enclosure frame;
a grouping of cylindrical battery cells held within the bottom enclosure frame;
a busbar module arranged over the grouping of cylindrical battery cells and including a busbar frame and a busbar system; and
a first fastener that secures the busbar frame to the bottom enclosure frame.

14. The traction battery pack as recited in claim 13, wherein the bottom enclosure frame establishes a bottom section of an enclosure frame of the battery system, and the busbar frame establishes a top section of the enclosure frame.

15. The traction battery pack as recited in claim 13, wherein the first fastener is received through a fastener housing of the busbar frame and extends into a stanchion of the bottom enclosure frame.

16. The traction battery pack as recited in claim 13, wherein the busbar frame includes a plurality of round windows and a plurality of crescent-shaped windows.

17. The traction battery pack as recited in claim 16, wherein the plurality of round windows establish first welding access points for welding a positive portion of the busbar system to the grouping of cylindrical battery cells, and the plurality of crescent-shaped windows establish second welding access points for welding a negative portion of the busbar system to the grouping of cylindrical battery cells.

18. The traction battery pack as recited in claim 13, wherein the busbar system electrically connects the grouping of cylindrical battery cells in a parallel/series configuration.

19. The traction battery pack as recited in claim 13, comprising a spacer that spaces the bottom enclosure frame apart from an enclosure tray of the enclosure assembly.

20. The traction battery pack as recited in claim 13, wherein the busbar system includes a negative terminal, a positive terminal, a plurality of short busbars, and a long busbar.
